(19) United States
(12) Patent Application Publication
(10) Pub. No.: US 2008/0057972 A1
(43) Pub. Date: Mar. 6, 2008

(54) METHOD FOR ALLOCATING RESOURCES IN A RADIO COMMUNICATION SYSTEM

(75) Inventors: Martin DOETTLING, Neubiberg (DE); Bernhard RAAF, Neuried (DE)

Correspondence Address: STAAS & HALSEY LLP, SUITE 700, 1201 NEW YORK AVENUE, N.W., WASHINGTON, DC, 20005, US

(73) Assignee: Nokia Siemens Network GmbH & Co., KG, Munich (DE)

(21) Appl. No.: 11/850,317

(22) Filed: Sep. 5, 2007

Related U.S. Application Data
(60) Provisional application No. 60/842,050, filed on Sep. 5, 2006.

(51) Int. Cl. H04Q 7/20

(52) U.S. Cl. 455/450

(57) ABSTRACT

According to the invention, a method for allocating resources in a radio communication system is proposed wherein a frequency carrier is subdivided into a number of sub carriers. The invention is characterised in that with a single information element transmitted between a base station of the radio communication system and at least one user terminal, at least two resource units (chunk,scheduling unit) are addressed.

The invention relates to a method for allocating resources in a radio communication system.

Forthcoming OFDM-based cellular systems, discussed e.g. the so called 3G long-term evolution project within the 3GPP standardisation, are seen to exploit multi-user diversity in frequency, time, and potentially also in space by using a flexible mapping of resources to user terminals. The scheduling units are called chunks and span adjacent symbols in time and frequency, e.g. according to coherence time and frequency or of predefined size. If additionally spatial processing is used, several spatial streams exist per chunk, and one stream, i.e., one chunk layer, is regarded as the smallest scheduling unit. Since in general many chunks are available per frame, the so-called resource map contributes a significant amount of control overhead if a flexible mapping of chunks to users is required.

As existing standards do not allow for a flexible mapping of chunks to user terminals, they also do not face the problem of extensive control overhead. Instead, resource mapping information may be transmitted with very little signalling in existing systems.

One possible solution to the problem would be to transmit in each frame a sequence of terminal addresses, wherein the sequence number of each address defines the shorthand id associated with the terminal address. Alternatively, a sequence of shorthand ids is given, where the sequence number implicitly identifies a corresponding chunk number.

While the complete terminal address requires in the order of Nₜₐ=16 bit signalling, the shorthand id requires only around N_{id}=4 . . . 6 bit, depending on the maximum number of allocated user per frame. Therefore the total signalling overhead would be reduced by a certain amount.

It is an object of the present invention to provide a method for further reducing the signalling overhead. This object is solved by the features of independent claim 1.

The present invention provides procedures for reducing the control overhead due to the resource map in downlink transmission while at the same time preserving flexible mapping of chunks to user terminals. The present invention furthermore reduces the overhead of the procedure outlined above and extends it to spatial processing.

In the following, flexible signalling procedures are described. For particular implementations, the proposed procedures may be simplified, e.g. by removing flexible parameterisation by fixed assignments. While all following examples assume resources in time, frequency and space, resource mapping spanning only a subset of these three dimensions is achieved in a straightforward manner by simply setting the corresponding index constant to one.

As an example, the following control information elements for resource mapping is proposed:

| information | Content | Comment | update rate |
|---|---|---|---|
| clustering | dimension in | | static, |
| dimension CD | which | | semi-static, |
| | neighbouring | | cell-specific |
| | resources can | | |
| | be addressed | | |
| | with one single | | |
| | entry in the | | |
| | resource map, | | |
| | e.g. “frequency”, | | |
| | “time”, “space” | | |
| maximum cluster | determines the | MCS = 0 implements | static, |
| size MCS | maximum number | the brute | semi-static, |
| | of adjacent resource | force approach, | cell-specific, |
| | to be | where each resource | or |
| | addressed with | element | user-specific |
| | one control information | is mapped individually | |
| | element | to an | |
| | | ID, determines | |
| | | the length of | |
| | | the cluster | |
| | | size (CS) field | |
| active terminals | maximum number | determines the | static, semi-static, |
| per | of active terminals | length of the | |
| frame Nᵤₛₑᵣ | per | terminal short- | |
| | frame | hand id (ID) | |
| | | field | |
| terminal address | system-wide | | static |
| AD | unique identifier | | |
| | of a terminal | | |
| shorthand id | frame-specific | Length of | frame-specific |
| ID | identifier of | shorthand id | |
| | terminal | field can be | |
| | | determined by | |
| | | knowledge of | |
| | | Nᵤₛₑᵣ, or dynamically | |
| | | detected | |
| | | by the | |
| | | length of the | |
| | | id map (see below) | |
| cluster size | number of resource | depending on | different |
| CS | elements | the clustering | for any |
| | the following | dimension, this | cluster of |
| | ID is mapped to | can be interpreted | chunk layers |
| | | as “number | |
| | | of spatial | |
| | | streams”, “number | |
| | | of adjacent | |
| | | frequency | |
| | | chunks”, “number | |
| | | of adjacent | |
| | | time chunks” | |
| | | the following | |
| | | ID is mapped to | |

Based on these information elements, an optimised signalling of the downlink resource map is achieved by the following layered control signalling:
the base station broadcasts static or semi-static configuration information:
   option a) clustering dimension CD (frequency, time, or space) and maximum cluster size MCS (Modulation and Coding Scheme), e.g. “# of spatial streams”, “number of adjacent frequency chunks”, “number of adjacent time chunks” field
      the cluster size determines the maximum number of adjacent scheduling units to be addressed with one control information element
      length of clustering field=0 bit would allow to switch to a direct approach.
   Nᵤₛₑᵣ=maximum number of active user terminals in one frame or any similar information that allows to detect the length and coding of the shorthand IDs
   in simple implementations, dimension and/or size and/or length of the id field could be even static, i.e. never be changed and consequently never be broadcasted in a system
in each frame there is an overall id map, which maps the user terminal addresses (e.g., 16 bit), sequentially to the shorthand ids
   the sequence of the user terminal addresses in the map determines implicitly the short hand id: n-th entry has id n
   if less than Nᵤₛₑᵣ are active two alternatives exist:
      fill the remaining entries with zeros
         disadvantage is that bits are wasted, however, the fixed length of the id map simplifies decoding
      add a reserved terminal address as “end” marker
         here, efficient use of bits is done, however, the the id map has variable length
      explicitly transmit the number of user terminal addresses as part of the id map.
         advantage: The length will be coded in less then 16 bit i.e. this coding is more efficient than the solution above, but in the worst case, i.e. if the maximum number of terminals is addressed, the total length gets longer (by the length of this dynamic length indicator). So the length of the id map will shrink on average, but the maximum length will increase.
   option b) for each terminal in the map there is a user-specific cluster size added
   option c) the Nᵤₛₑᵣ information is not a semi-static information but detected dynamically from the number and position of the user terminal ids in the header
      this requires to send the id map separately from the frame resource map, but allows further optimization of the overhead
      a unique end marker is required to detect the end of the terminal addresses
   option d) the overall id map is of fixed size and includes a further control information element, which indicates the length of the resource mapping information (e.g. occupied symbols of encoded block, length of uncoded information, code rate, etc.)
   for HARQ (Hybrid Automatic Repeat Request), additionally the ids of user terminals that shall report channel state information may be required to be broadcasted. Also in schemes where the uplink allocation is controlled by the network, the allocation for the following uplink phase need to be signaled. In such cases, those ids could be merged with the ids of the user terminals that currently receive data in this frame and a marker field that indicates, whether the corresponding id receives data and/or shall report channel state information and/or is scheduled for the subsequent uplink phase.
in each frame and for each available chunk layer there is resource mapping information consisting of:
   option e):
   CS|ID|CS|ID|CS|ID|CS|=0=“end”
      option a) is required for varying cluster sizes (i.e. normally recommended for clustering in frequency direction, would also allow different spatial processing per frame for each user (e.g. flows with different QoS) if used in spatial dimension,
   option f):
         |ID|ID|ID=0=“end”
      option b) forces identical clustering per user
   depending on (semi-)static information this procedure works sequentially over spatial layers, frequency-chunks, or time slots (more generally, the procedure works at least over one of the above)
   the chunk layers are identified by processing the resource mapping information, i.e. the current sum of the CS information together with an a-priori known sequence of physical chunk layers allows to identify the physical resources implicitly.
   “end” markers are only required when the calculated sum of all entries is lower than the corresponding size of the dimension (e.g. number of spatial layers, frequency-chunks, or time slots)

This scheme applies to all users and resources that use adaptive transmission, i.e. a flexible allocation of chunk layers to users depending on the channel properties.

Additionally the ID-Information may be further compressed if users are often assigned only a single area or a few areas. The ID of the user is replaced by an IDF (ID Format) followed by an IDV (ID Value). The IDF can take two values (may thus be coded in one bit) and indicates whether:
1) The full length terminal address is to be used. This is the case when the user is mentioned for the first time in the resource map. Note that for the first entry in the resource map this will necessarily be the case so the IDF can be skipped for the first entry. Actually, if it is possible to allocate all or a sufficient number of resource units with one entry in the resource map, also the second entry in the resource map must use the full length terminal address, because the second entry addresses another user than the first entry. Even if in exceptional cases this might happen, there is no harm if in these few cases the full length address is used, because this is expected to be an extremely rare event. Implicitly, when a full length terminal address is used, the next free shorthand ID is associated to the terminal address.
2) The shorthand ID, which was allocated previously under 1) is used. Obviously, in both approaches the full length address of each scheduled user has to be coded once, so it may be ignored for the comparison of the coding efficiency. The shorthand ID however, needs to be used only at the second (and further) occurrence of a user in the resource map, which means that for each user the bit size of the shorthand ID (typically around N_{id}=4 . . . 6 bit) is saved. However, for each occurrence of a user the IDF (one bit) needs to be coded. Consequently, this enhanced format is advantageous, if each user is mentioned on average at most 4 . . . 6 times in the resource map.

Further optimization of coding of shorthand ID

For any of the above implementation variants, the shorthand ID can be coded even better than by using 4 . . . 6 bit. According to the invention, the convention is made that the occurrence of the shorthand IDs appears always in their order, i.e. ID=0 is used first, then ID=1, then ID=3, and so on. Of course an ID that already appeared can also reappear. Then the receiver has the knowledge, that the maximum value of the ID is one plus the previously largest ID. This can be used to reduce the bit size for coding: Instead of using e.g. 16 times 4 bit, i.e. in total 64 bits, we can use

| | |
|---|---|
| 0 bit for the first occurence (ID = 0) | total 0 |
| 1 bit for the 2nd occurence (ID = 0 . . . 1) | total 1 |
| 2 bit for the occurence #3-4 (ID = 0 . . . 3) | total 4 |
| 3 bit for the occurence #5-8 (ID = 0 . . . 7) | total 12 |
| 4 bit for the occurence #9-16 (ID = 0 . . . 15) | total 32 |

This gives a grand total of 39 bit i.e. a saving of 25 bit or some 40%.

There are two ways to set the length of the ID coding. It can either be allocated according to the worst case i.e. no reappearing n IDs. Obviously this allocation will also work in the case that some IDs reappear. Alternatively, the length can be set according to the actually appeard IDs. In case that some IDs reappear, the use of longer Bitsizes can be delayed accordingly. If IDs are used often repeatedly, there is even more gain than calculated above. In this case (reappearing IDs) the scheduling message will tend to be longer anyhow so a saving is particularly relevant in this case.

Non adaptive transmissions:

Additionally, non-adaptive transmissions may be scheduled in parallel. Here users do not perform link adaptation but rely e.g. on frequency diversity instead. The above scheme can be easily extended to accommodate also such users. One way is to use chunk layers with a regular interval for those users, e.g. use k chunk layers starting from chunk layer c₀, with distance Δc between the layers. If these non-adaptive users are also to be scheduled on a frame-basis, one could add the information cₒ, k, and Δc right after the corresponding user entry in the id map. Furthermore, even c₀ can be omitted, since the sequence of the user ID can be directly linked to the start chunk c₀ by a fixed algorithm.

For scheduling on a longer time base, such information should be sent with an appropriate update rate. In any case the resources available for adaptive transmission are determined by detecting the resources used for non-adaptive transmission and excluding them from the algorithm to map user IDs to chunk layers for adaptive transmission.

However, according to a further aspect, a dummy user is introduced and considered for the scheduling message. Basically, this user will get those resources which are not to be used for adaptively scheduled users. In a second step, these resources of the dummy user are then distributed to the nonadaptive transmission users in a predetermined way, e.g. a user which gets 1/n of the non-adaptive transmission capacity could be allocated every n-th resource unit. In case no users are scheduled adaptively, both approaches will yield the same result, but if both adaptive and non adaptive users are scheduled the result is different: If the non adaptive users are scheduled first, they will be perfectly interleaved over the entire resource units, if they are scheduled last, there is a risk that the left over resources are concentrated in a specific area and then the diversity for the non-adaptively scheduled users is lost. However, if during scheduling of the adaptive users this is taken into account, both adaptively and non-adaptively scheduled users can be served optimally. The advantage of this approach is, that there is less likelihood that a non-adaptive user takes away a resource unit that would be ideally suited for an adaptively scheduled user and thus degrades performance. By scheduling the adaptive user first it can take the optimum resource unit and the resource unit for the non-adaptively scheduled user is shifted somewhat, but this should not harm the performance.

Application of Huffman coding

Additional overhead reduction can be achieved by compression algorithms (e.g., Huffman) if decoding complexity and processing time constraints allow. Two main alternatives exist. Either such compression algorithms can be applied on the actual data, or a predefined coding is used for individual parts of the control message (based on a-priori long-term optimization of the expected control information), e.g. the following coding could be used for the cluster size in a system where no clustering (cluster length=1) prevails:
1: cluster length=1
01: cluster length=2
10: cluster length=3

In a similar way such coding can be applied to the ID field: terminals which receive high data rates and thus require multiple entries in the resource map use shorter ID words than those which only use few resources. In this case the sequence of the entries in the id map would determine the mapping of the terminal address to code words for the ID.

Further variants

The control information outlined above can also include further control information, like uplink resource mapping, candidate information for CQI reporting, etc.

The optimized structure results in a resource mapping information with variable length. After encoding this information two basic approaches can be distinguished:
fixed length of coded information
   the length has to be pre-determined and can be set according to a given criterion to an average length that allows reasonable flexibility in possible signaling,
   considering the variable length of the information, this results in a variable code rate
   depending on the code rate, the power of the control information can be adjusted accordingly
   for messages that allow high compression, no additional resources are obtained, however, at least the power of the control message can be reduced
   this requires outband information on code rate or length of the uncoded information, e.g. in the overall id map (see option c) there)
assuming fixed code rate
   this results in a variable code block length
   code block length needs to be signalled outband, e.g. in the overall id map (see option c) there)
   for messages that allow high compression, additional resources for data transmission are obtained

The required outband signaling (code rate, or code block length) must be signaled beforehand, preferably together with additional control signaling that is required with the same update rate (e.g. candidate identification for next DL used as a trigger to send CQI report)

The following advantages are gained:
reduced overall control overhead and therefore higher spectral efficiency by layering of control information and efficient source coding
control overhead becomes proportional to the degree of adaptivity and to cell load: in sparsely loaded cells or when few adaptivity is used (i.e., when the overall throughput is expected to be lower), the overhead is also reduced

Considering the high overhead percentage, such compression algorithms are crucial to allow fast and flexible allocation of resources to users and to benefit from the corresponding scheduling gain.

Based on simplifying assumptions first investigations have been conducted to investigate preferable implementations of the above concepts. First clustering in the frequency domain is investigated. We make the worst-case assumption that the allocation of two neighboring chunks to users is completely uncorrelated. Also we do not use additional source compression algorithms. We investigate the optimum clustering size for different configurations. Assuming 104 chunks and 4 adaptive users, each having 26 chunks, a maximum cluster size of 2 (1 bit) allows to reduce the resource mapping overhead by around 7% even under these worst-case assumptions. Significantly higher gain is expected for the realistic case of correlation between adjacent chunks. However, the use of nonadaptive transmissions with IFDMA-like comb structure might reduce the potential for clustering in the frequency domain. Therefore also clustering in the spatial domain has been investigated.

In the following figures the following formats are assumed as exemplary implementations of the above concept:

Ref:
brute force encoding, used as reference
id map:
   16-bit terminal address: Nᵤₛₑᵣ entries
resource mapping information:
         |ID|ID|ID|ID|: Nᵥₐ entries for all chunks:

OP1:
id map:
   16-bit terminal address: Nᵤₛₑᵣ entries
resource mapping information:
         |ID|Dc|k|CS| for all non-adaptive terminal
   ID=0=“end”
         |ID|ID|ID| . . . Nᵥₐ entries for all remaining chunks (adaptive transmissions only)

OP2:
id map:
   16-bit terminal address: Nᵤₛₑᵣ entries
resource mapping information:
   option e): |CS|ID|CS|ID|CS|ID|CS|=0=“end”

OP3:
id map:
   option b): 16-bit terminal address|MCS|: Nᵤₛₑᵣ entries
resource mapping information:
   option f): |ID|ID|ID|ID|ID=0=“end” for all chunks

OP4:
id map:
   16-bit terminal address: Nᵤₛₑᵣ entries
resource mapping information:
         |ID|Dc|k|CS| for all non-adaptive terminal
   ID=0=“end”
   option e): |CS|ID|CS|ID|CS|ID|CS|=0=“end”

OP5:
id map:
   option b) : 16-bit terminal address|MCS|: Nᵤₛₑᵣ entries
resource mapping information:
         |ID|Dc|k|CS| for all non-adaptive terminal
   ID=0=“end”
   option f): |ID ID|ID|ID|ID=0=“end” for all chunks

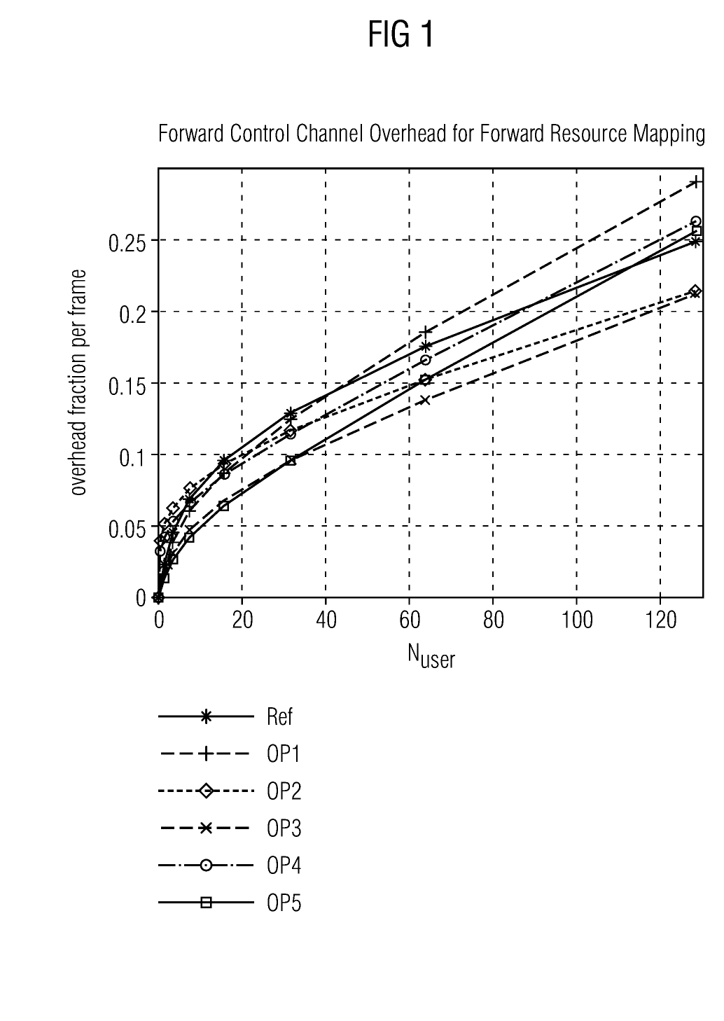

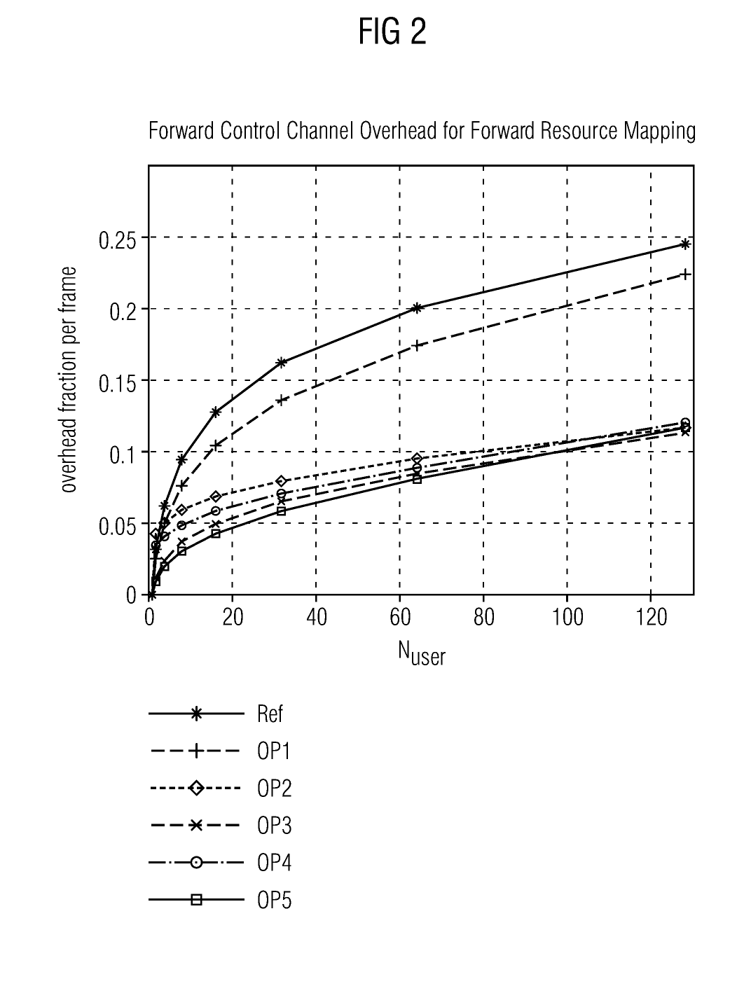

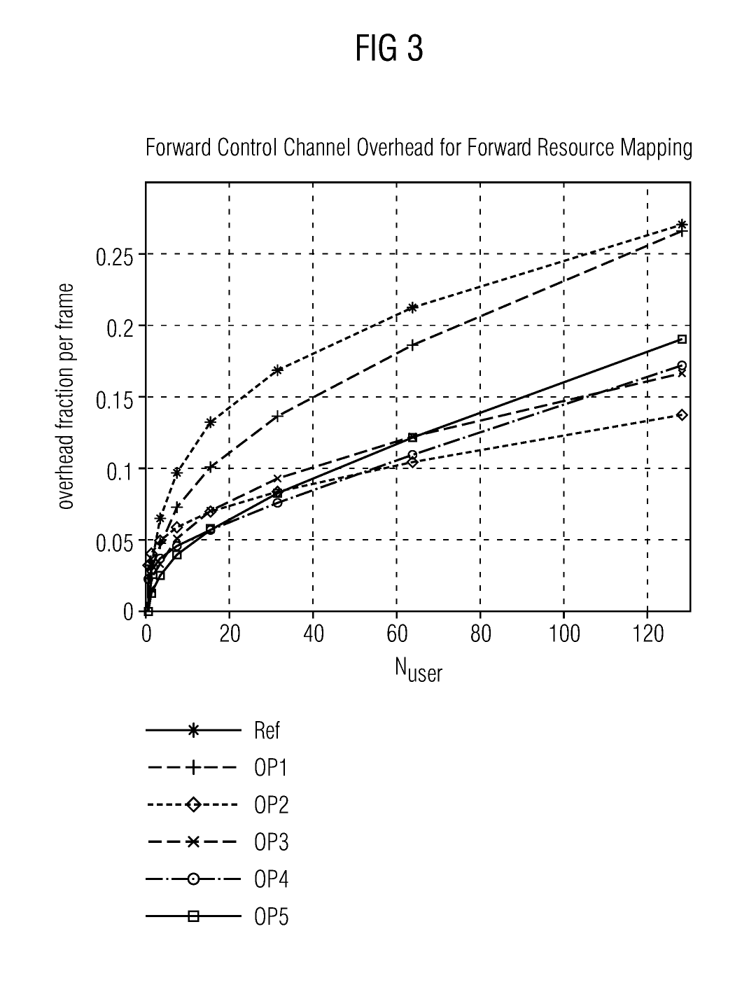

The figures compare these different variants. FIG. 1 shows a wide area setting (52 chunks per frame, transmission e.g. based on grid of beams combined with open-loop spatial processing). For realistic Nᵤₛₑᵣ values ranging from 16 to 64 up to 35% overhead reduction can be achieved. In the short-range mode (characterised by 3*104 chunks per frame and increased use of spatial multiplexing) the possible gains are even higher, see FIG. 2 and 3. Here an overhead reduction of over 50% seems feasible.

It can be concluded that the present invention provides a flexible toolbox for usage in a procedure which can configure the coding of resource mapping information in a very efficient way for a large variety of operational scenarios.

FIG. 1 shows an example based on the following assumptions: 52 chunks, 8 antennas, 50% adaptive users using 80% of the resource, on average 4 users separated by SDMA per chunk, on average 1.5 spatial multiplexing.

FIG. 2 shows a second example based on the following assumptions: 104*3 chunks, 8 antennas, 50% adaptive users using 80% of the resource, on average 2 users separated by SDMA per chunk, on average 2 spatial multiplexing.

FIG. 3 shows a third example based on the following assumptions: 104*3 chunks, 4 antennas, 30% adaptive users using 70% of the resource, on average 1 users separated by SDMA per chunk, on average 2 spatial multiplexing

1. Method for allocating resources in a radio communication system, wherein a frequency carrier is subdivided into a number of sub carriers,
characterised in that
with a single information element transmitted between a base station of the radio communication system and at least one user terminal, at least two resource units (chunk,scheduling unit) are addressed.

2. Method according to claim 1, wherein the at least one user terminal is addressed by using shortened identifications of the user terminals.

3. Radio communication system, comprising means for realising the method according to claim 1.
